(19) United States
(12) Patent Application Publication
(10) Pub. No.: US 2023/0336347 A1
(43) Pub. Date: Oct. 19, 2023

(54) TOKEN-BASED ACCESS CONTROL WITH AUTHENTICATION DATA

(71) Applicant: Schweitzer Engineering Laboratories, Inc., Pullman, WA (US)

(72) Inventor: George W. Masters, Moscow, ID (US)

(73) Assignee: Schweitzer Engineering Laboratories, Inc., Pullman, WA (US)

(21) Appl. No.: 17/659,029

(22) Filed: Apr. 13, 2022

(51) Int. Cl. H04L 9/32; H04L 9/06

(52) U.S. Cl. CPC H04L 9/3213; H04L 9/0643; H04L 9/3239

(57) ABSTRACT

The present disclosure relates to token-based authentication that uses authentication data including a personal identification number (PIN). For example, an issuer may obtain privilege information including the PIN. The issuer may combine the privilege information with authentication information. The issuer may determine an issuer hash value based on the combined privilege information and authentication information. The issuer may determine an encrypted hash value based on the issuer hash value and a private key of the issuer. The issuer may combine the privilege information with the encrypted hash value as a token. The issuer may then issue the token. The receiver can restrict allowed operations appropriately based on success decrypting the encrypted hash.

### TECHNICAL FIELD

The present disclosure relates generally to authentication and, more particularly, to a token-based system that uses authentication information.

### BRIEF DESCRIPTION OF THE DRAWINGS

Non-limiting and non-exhaustive embodiments of the disclosure are described herein, including various embodiments of the disclosure with reference to the figures listed below.

FIG. 1 is a block diagram of communication of a token between a sending device and a receiving device, in accordance with an embodiment.

FIG. 2 is a block diagram of a process performed by the sending device and the receiving device to authenticate the token of FIG. 1, in accordance with an embodiment.

FIG. 3 is a block diagram of the sending device and the receiving device of FIGS. 1 and 2, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When communicating data, authentication processes may be used to verify the identity of an issuer. To confirm that the issuer of a token is in fact the claimed issuer, a receiver authenticates a received token using a public key of the issuer. In some cases, the issuer may provide the token to a bearer, or an operator who transports the token to the receiver. Some forms of token-based authentication may grant the bearer of the token any of the authorizations bound within the token itself. That is, the bearer transporting the token may be granted authority according to the token due to possession of the token, also referred to as a bearer token.

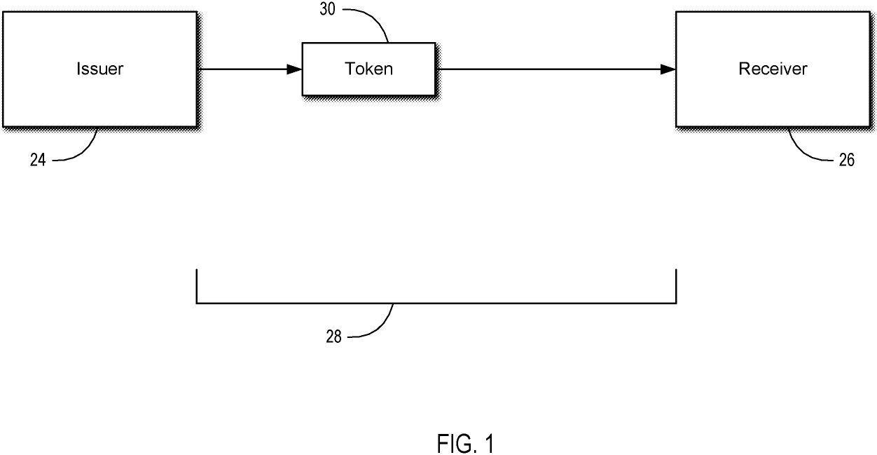

FIG. 1 is a block diagram of communication from an issuer 24 to a receiver 26 via a bearer 28, over a communication network, or using another method of communication using token-based authentication. In some embodiments, the issuer 24 may be a token issuance server, or token presenter, that has a closely guarded private key that is used to digitally sign tokens. The token 30 may include privilege information and identity information of subjects bounded within the token 30 to identify the subjects and corresponding access rights permitted by each subject.

In some cases, the token 30 may be included with data content, which may be embodied as an electronic file (e.g., electronic document), an electronic message, or any other set of electronic information. For example, the token 30 may include a list of subjects allowed to access the electronic document, portions (e.g., work instructions) of the electronic document that each of the subjects are allowed to access, times the electronic document is valid, and the like.

An impersonator may attempt to send inauthentic data content, as if it were the issuer 24, to the receiver 26. In some token-based authentication processes, the token 30 may include a digital signature to prevent such impersonations. For example, asymmetric encryption is a technique that may be used to allow the receiver 26 to verify that the token 30 is in fact from the issuer 24. As explained below, the encryption process may be used with privilege information and authentication information to ensure that the bearer in fact is the person to whom the corresponding privileges are granted according to the token 30.

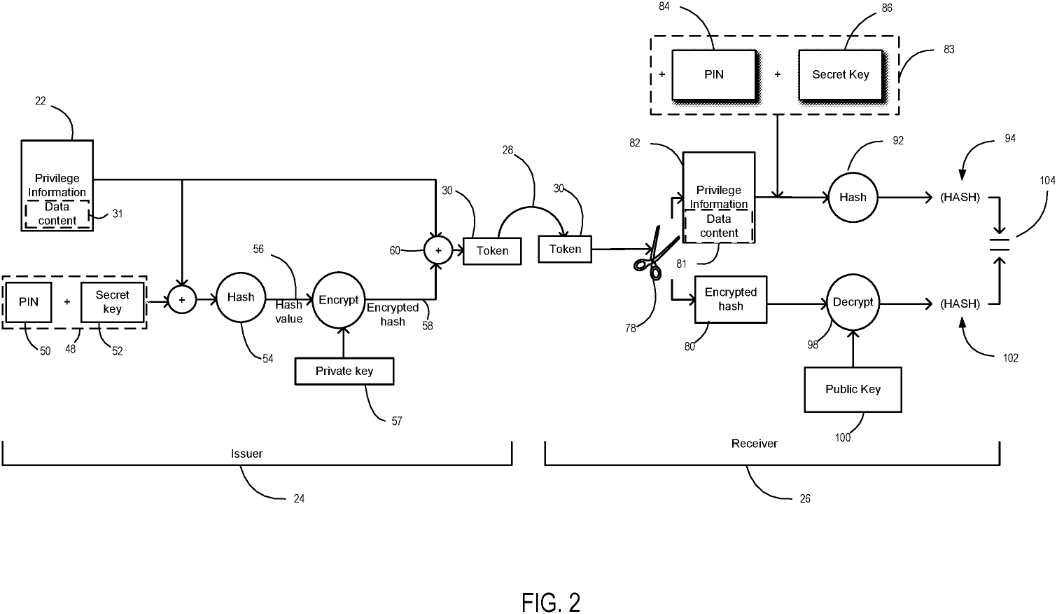

FIG. 2 is a more detailed block diagram of the token-based authentication process performed by the issuer 24 and the receiver 26 to authenticate the data content 31 that also ensures the bearer in fact is authorized to use the token 30 according to privileges granted to the subject. The issuer 24 may obtain identity information and/or privilege information associated with the data content 31, such as subject access to particular portions of a document associated with the token, a time period in which the token is valid, etc. For instance, the token may limit access to a work instruction in the document to one subject for a period of time and allow access to a different work instruction in the document to a different subject for a different period of time.

The issuer 24 may use receiver authentication data 48 to ensure that the bearer and receiver 26 are in fact authorized to use the data content 31. In the illustrated embodiment, the issuer 24 may include a personal identification number (PIN) 50 and a device key 52 as the receiver authentication data to authenticate the bearer 28 of the token 30. The issuer 24 may send signals to a display to prompt an operator to enter a PIN 50. The issuer 24 may receive the PIN 50 that may be associated with the token 30. The PIN 50 may include letters, numbers, or other suitable characters that are used to authenticate the bearer of the token. In some embodiments, the PIN 50 may be randomly generated and shown to the operator to use later. In other embodiments, an operator may enter a desired PIN to use. The PIN 50 may be communicated using a communication channel (e.g., via telephone) other than the communication channel (e.g., ethernet) used to communicate the token 30 to the bearer 28. The PIN 50 may be associated with entries in the privilege information 22 that specify the access rights to the data content 31, such as an amount of time in which the PIN 50 is valid for a particular subject.

The issuer 24 may acquire a device key 52 that is associated with the receiver 26. The device key 52 may be based on a serial number, a mac address, or other unique identifier associated with physical hardware of the receiver 26. In other embodiments, the device key 52 may be a randomly generated number associated with the receiver 26. For example, the issuer 24 may be a control station that sends work authorizations/instructions to workers that use various receivers. In certain embodiments, the device key may be assigned to a group of devices with users of a particular population (e.g., a group of users with a particular security clearance). By including a device key 24 that is associated with the particular receiver 26 or a set of receiving devices, access to the data content 31 may be limited to that receiver 26 or set of receiving devices.

In some embodiments, the issuer 24 may store a list of receivers and corresponding device keys of each of the receivers in a look-up table. The issuer 24 may receive a selection of the receiver 26 from the list of receivers intended to be the recipient of the token 30 and the data content 31. The issuer 24 may determine the corresponding device key of the selected receiver 26 via the look-up table.

The privilege information 22, the PIN 50, and the device key 52 may be combined to be hashed together. For example, the PIN 50 and the device key 52 may be appended to the privilege information 22. The issuer 24 may use a hash function 54 to hash the combined privilege information 22, PIN 50, and device key 52 to obtain an issuer hash value 56, which refers to a unique set of characters output from the hash function 54. In some embodiments, the data content 31 may be included in the information (e.g., the privilege information 22, the PIN 50, and the device key 52) being hashed together.

The issuer 24 may then digitally sign (i.e., encrypt) the hash value 56 using a private key of the issuer 24 to obtain a digital signature. The issuer 24 may have a private key that is not publicly known and a public key, mathematically related to the private key, that is publicly known. The public key may be used by the receiver 26 to decrypt the encrypted hash via the private key to verify that the token 30 was in fact encrypted by the issuer 24, thereby representing a digital signature of the issuer. The encrypted hash 58 may then be combined 60 with the privilege information (e.g., a plain text copy of the privilege information) to form a token 30. For example, the token 30 may have characters from the encrypted hash 58 appended to the privilege information and the data content as a digital signature to allow the receiver 26 of the token 30 to verify that the token was in fact issued by the issuer 24. The digital signature may also allow the receiver 26 of the token 30 to verify that the privilege information 22 is intact and unmodified.

The receiver 26 may then receive the token 30 from a bearer transporting the token 30. The receiver 26 may separate 78 the received privilege information 82 from the encrypted hash 80. The receiver 26 may then obtain the receiver authentication data 82. For example, the receiver 26 may display a prompt requesting that the bearer 28 enter the PIN 84. The receiver 26 may receive the PIN 84 via inputs from the bearer 28 at a terminal of the receiver 26. Further, the receiver 26 may retrieve a device key 86 stored in the memory of the receiver 26.

The receiver 26 may determine a first receiver hash value 94 by hashing the received privilege information 82 and the data content 81 combined with the receiver authentication data 83. For instance, the PIN 84 and the device key 86 may be appended to the received privilege information 82 and data content 81 to match the characters inserted into the hash function 54 by the issuer 24. The combination of the privilege information 78 the PIN 84, and the device key 86 may be hashed by the hash function 92 to determine a first receiver hash value 94. Because the combination of inputs (e.g., the privilege information 82, data content 81, the PIN 84, and the device key 86) into the hash function 92 matches the combination of inputs (e.g., the privilege information 22, data content 31, the PIN 50, and device key 52) into the hash function 54, the first receiver hash value 94 output from the hash function 92 matches the issuer hash value 56 output from the hash function 54 of the issuer 24. That is, when each of the characters the inputs are combined in the same order and input into the hash function 92, then the output of the hash function 92 matches the output of the hash function 52 when the same characters are combined in the same order and input into the hash function 52.

The receiver 26 may determine a second receiver hash value 102 by decrypting 98 the received encrypted hash value 80 using the public key 100 of the issuer 24. For example, the receiver 26 may obtain the public key of the issuer via a registry or listing of available public keys or may obtain the public key from memory of the receiver 26. The received encrypted hash 80 corresponds to the sent encrypted hash 58 sent by the issuer 24. As mentioned above, the public key 100 is mathematically related to the private key 57 such that the public key 100 is used to decrypt data that has been encrypted by the private key 57. The decrypted hash value 102 may then match the hash value 56 of the issuer 24.

If the second receiver hash value 102 obtained from the decrypting 98 the encrypted hash 80 matches the first receiver hash value 94 obtained from hashing 92 the privilege information, the PIN 84, and the device key 86, then the token 30 is authentic (i.e., the issuer 24 actually sent the token 30). That is, the receiver 26 may authenticate the token 30 based on the first receiver hash value 94 matching the second receiver hash value 102. If the first receiver hash value 94 does not match the second receiver hash value 102, the receiver 26 may send a notification to the issuer 24 to log the attempted authentication when the first hash value does not match the second hash value. If the first receiver hash value 94 matches the second receiver hash value 102, the receiver 26 may grant access to the data contents 31 according to the token 30 based on the PIN 84 and the device key 86. That is, the bearer 28 may be allowed to use the data content 31 according to the privileges of the subject associated with the PIN 50. Further, the operations performed by the bearer 28 may be logged as being associated with the subject who issued the PIN 50.

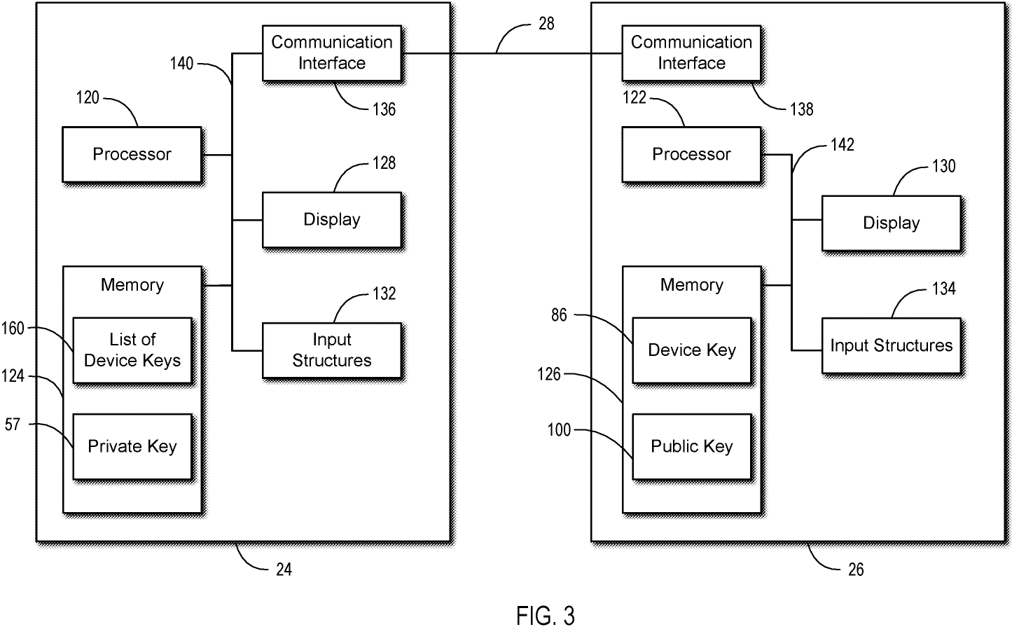

FIG. 3 is a block diagram of the issuer 24 and the receiver 26 in the process described with respect to FIGS. 1 and 2. As illustrated, the issuer 24 and the receiver 26 may each be electronic devices that include one or more processor(s) 120 and 122, computer-readable storage media (e.g., memory 124 and 126), displays 128 and 130, input structures 132 and 134, and communication interfaces 136 and 138 communicatively connected via one or more buses 140 and 142. The computer-readable storage media may include or interface with software, hardware, or firmware modules for implementing various portions of the systems and methods described herein. The computer-readable storage media may be the repository of one or more modules and/or executable instructions (e.g., code) configured to implement any of the processes described herein, such as the processes described with respect to FIGS. 1 and 2. The computer-readable media may be embodied as random access memory (RAM), read only memory (ROM), electrically erasable programmable read-only memory (EEPROM), or any other suitable computer-readable media or combination of media. In some embodiments, the computer-readable storage media and the modules therein may all be implemented as hardware components, such as via discrete electrical components, via a Field Programmable Gate Array (“FPGA”), and/or via one or more Application Specific Integrated Circuits (“ASICs”).

The processors 120 and 122 may be configured to process inputs received via the input structures 132 and 134 and the communication interfaces 136 and 138. The processors 120 and 122 may operate using any number of processing rates and architectures. The processors 120 and 122 may be configured to perform various algorithms and calculations described herein, such as the process described with respect to FIG. 2, using computer executable instructions stored on computer-readable storage media 124 and 126. The processors 120 and 122 may be embodied as microprocessors, general-purpose integrated circuits, ASICs, FPGAs, and/or other programmable logic devices. In some embodiments, the processors 120 and 122 and/or the memory 124 and 126 may be referred to generally as processing circuitry.

The communication interfaces 136 and 138 may include communication circuitry, such as a transceiver and/or output connections (e.g., ethernet connections) to communicate with each other and/or other electronic devices. For example, the communication interfaces 136 and 138 may allow a communication path to communicate the token 30. In some embodiments, the issuer may send the token 30 to be stored onto a portable device. For example, the issuer 24 may save the token 30 and related data content 31 onto a flash drive, external hard drive, compact disc, or the like.

As illustrated, the issuer 24 and the receiver 26 may include input structures (e.g., keyboard, mouse, touchscreen, etc.) that allow the issuer 24 and receiver 26 to receive inputs from the operators of the issuer 24 and the bearer 28. For example, the bearer may obtain the portable device from the issuer 24, the subject, or an operator of the issuer 24, transport the portable device to the receiver 26, and use the inputs (e.g., universal serial bus (USB) port) of the receiver 24 to load the portable device onto the receiver 26 to allow the receiver 24 to perform the processes described with respect to FIG. 2.

The issuer 24 and the receiving device 26 may include a display screen 128 and 130 that allows the issuer 24 and the receiver 26 to communicate information to operators of the issuer 24 and bearers. For example, the issuer 24 may display a prompt on the display screen 128 showing a list of potential receivers and/or receiving devices to allow an operator to select a desired receiver. Upon receiving a selection from the operator of a desired receiver, the issuer 24 may insert the device key 52 of the selected receiver 26 from a table with a list of device keys 160 when performing the hash function 54. The issuer 24 may display a prompt on the display screen 128 to prompt the operator to input a PIN 50 and any access rights (e.g., time constraints) associated with the PIN 50. As mentioned above, the issuer 24 may use the private key 57 from the memory 124 to obtain the encrypted hash 58. The PIN 50 from the operator may be delivered to the bearer via a separate communication path (e.g., phone call) from the communication path in which the token 30 is delivered. The PIN 50 may be communicated directly between the operator issuing the token and the bearer, or in other embodiments, the PIN 50 may be communicated indirectly through intermediate operators, such as the subject. Further, the device key may be kept secret from any devices other than the issuer 24 and the receiver 26. For example, the issuer 24 may be part of a central security system that includes secret keys of each of the receiving devices while the receiving devices may maintain secrecy of the device key for the particular device to prevent other receivers from accessing data content 31 without authorization in the privilege information 22.

The receiver 26 may cause the display 130 to display a prompt for the bearer to enter a PIN. The processor 122 may retrieve, from the memory, the device key 86 of the receiver 26 and include the entered PIN from the input structures 134 into the privilege information as discussed above. Further, the receiver 26 may retrieve, from the memory or from the communication interface 138, the public key of the issuer 24.

In some embodiments, the PIN 84 and/or the device key 86 inserted into the hash function 54 may be used to limit authorization and/or use of received data content 31 associated with the token 30. For example, the token 30 may include access rights and/or privileges of various subjects. The data content 31 may include instructions to limit access within the data content 31 depending on the subject associated with the PIN 84 and the device key 86. The authorizations from the privilege information 78, the PIN 84, and the device key 86 may prevent the receiver from possessing a bearer token in which the bearer has any of the rights granted by the token due to possession. By limiting the bearer to the privileges associated with the PIN of a subject, the system may be better protected from unauthorized uses.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]...” or “step for [perform]ing [a function]...”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
obtaining, via an issuer, privilege information;
combining, via the issuer, the privilege information with authentication information;
determining, via the issuer, an issuer hash value based on the combined privilege information and authentication information;
determining, via the issuer, an encrypted hash value based on the issuer hash value and a private key;
combining, via the issuer, the privilege information with the encrypted hash value as a token; and
issuing, via the issuer, the token.

2. The method of claim 1, comprising receiving, via a user interface of the issuer, a personal identification number (PIN) as the authentication information to associate with a subject in the privilege information of the token.

3. The method of claim 2, comprising obtaining a receiver key from a list of receivers to associate with the token.

4. The method of claim 3, wherein combining the privilege information with authentication information comprises appending the PIN and the receiving device key to the privilege information.

5. The method of claim 1, wherein the issuer is a token issuance server.

6. The method of claim 1, comprising:
obtaining, via a receiver, the token comprising the privilege information and the encrypted hash value;
obtaining, via user inputs of the receiver, authentication information;
determining, via the receiver, a first receiver hash value based at least in part on a combination of the privilege information and the authentication information;
determining, via the receiver, a second receiver device hash value by decrypting the encrypted hash value using a public key of the issuer; and
authenticating, via the receiver, the token based on the first receiver hash value matching the second receiver hash value.

7. The method of claim 1, comprising an electronic document having the privilege information, wherein access to the electronic document is limited according to the privilege information, wherein the electronic document is hashed along with the privilege information, PIN, and device key.

8. An issuer, comprising:
memory; and
a processor operatively coupled to the memory, wherein the processor is configured to execute instructions to cause operations comprising:
obtaining privilege information;
combining the privilege information with authentication information;
determining an issuer hash value based on the combined privilege information and authentication information;
determining an encrypted hash value based on the issuer hash value and a private key of the issuer;
combining the privilege information with the encrypted hash value as a token; and
issuing the token.

9. The issuer of claim 8, wherein the private key is mathematically related to a public key such that the public key decrypts the encrypted hash value.

10. The issuer of claim 8, wherein the privilege information comprises a list of subjects and a privilege associated with each subject, wherein each privilege indicates allowed uses of data content associated with the token.

11. The issuer of claim 8, wherein the processor is configured to execute instructions to cause operations comprising receiving a notification from the receiver indicating an attempted authentication when the receiver uses different authentication information.

12. The issuer of claim 8, wherein the processor is configured to execute instructions to cause operations comprising:
receiving, via a user input, a selection of a receiver in which to send the token; and
determining a device key of the selected receiver to include as the authentication information.

13. A receiver, comprising:
memory; and
a processor operatively coupled to the memory, wherein the processor is configured to execute instructions to cause operations comprising:
obtaining a token comprising privilege information and an encrypted hash value;
obtaining authentication information;
determining a first receiver hash value based at least in part on a combination of the privilege information and the authentication information;
determining a second receiver hash value by decrypting the encrypted hash value using a public key of an issuer of the token; and
authenticating the token based on the first receiver hash value matching the second receiver hash value.

14. The receiver of claim 13, wherein the one or more processors are configured to:
acquire a public key associated with the issuer; and
decrypt the encrypted hash value using the public key to obtain the second receiver hash value.

15. The receiver of claim 13, wherein the authentication information comprises a device key that is based on a media access control (MAC) address or a serial number that is unique to the receiver.

16. The receiver of claim 15, wherein the authentication information comprises a personal identification number (PIN), comprising one or more letters, numbers, or combination thereof, entered by a user at the receiver.

17. The receiver of claim 16, wherein the processor is configured to execute instructions to cause operations comprising limiting use of data content associated with the token according to privilege information for a subject associated with the PIN.

18. The receiver of claim 16, wherein the PIN and the device key are appended to the privilege information in the same order as when the issuer hashed the privilege information, the PIN, and the device key.

19. The receiver of claim 13, wherein the receiver is configured to obtain, via a universal serial bus (USB), the token from a portable device, and to obtain, via a user interface of the receiver, the authentication information.

20. The receiver of claim 13, wherein the processor is configured to execute instructions to cause operations comprising sending a signal indicating a security event when the first receiver hash value does not match the second receiver hash value.
